(19) United States
(12) Patent Application Publication
(10) Pub. No.: US 2007/0118660 A1
(43) Pub. Date: May 24, 2007

(54) Recording session contents in a network

(75) Inventor: Miguel Garcia-Martin, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/349,263

(22) Filed: Feb. 8, 2006

(30) Foreign Application Priority Data
Nov. 24, 2005 (EP) 05 025 716.1

(51) Int. Cl. G06F 15/16

(52) U.S. Cl. 709/227

(57) ABSTRACT

A mechanism is disclosed whereby contents associated with a session can be stored in a network. A user can indicate commands such as start recording and stop recording in the network. The network can inform the user when recording stopped, perhaps due to reaching a storing limit or some error condition.

The present invention relates to recording session contents in a network. In particular, the present invention relates to recording session contents such as messages, voice and video contents in an Internet Protocol (IP) multimedia subsystem (IMS) in which session control is performed using SIP (Session Initiation Protocol).

Current developments in the field of mobile communications networks suggest that session contents could be stored in the network. For example, Instant Messaging (IM) conversations using SIP should be stored in the network.

Currently, there is no mechanism to perform such operation. A web page could be implemented for this purpose, with some refresh timer to refresh the status of recording activity. In addition, prior art messengers implement a chat history at the client.

The present invention provides a mechanism whereby contents associated with a session can be stored in the network. A user can indicate commands such as start recording and stop recording in the network. The network can inform the user when recording stopped, perhaps due to reaching a storing limit or some error condition.

The advantage of using SIP in the above mechanism is that there is no requirement to establish an additional PDP (Packet Data Protocol) context for HTTP (HyperText Transfer Protocol) or RTSP (Realtime Streaming Protocol), there is no need to develop new authentication or security mechanisms linked to any additional protocol, since IMS SIP security mechanisms are used, and there is no need for a UE (User Equipment) to learn an HTTP or RTSP URI (Uniform Resource Identifier), because the mechanism presented in this invention addresses SIP requests to the user “himself”: the requests are trapped in an S-CSCF (Serving Call State Control Function) through initial filter criteria and routed to a recording application server. Moreover, since SIP offers real-time capabilities, it is expected that processing of the commands takes place in real-time as well.

Besides recording Instant Messages in the network, the mechanism according to the invention is applicable to record any other type of media, such as voice and video in the network as well.

### BRIEF DESCRIPTION OF THE DRAWINGS

FIG. 1 shows a schematic block diagram illustrating a network device and terminal devices according to an embodiment of the invention.

FIG. 2 shows a schematic block diagram illustrating a network device and terminal devices according to another embodiment of the invention.

FIG. 3 shows a signaling diagram illustrating an implementation example of the invention according to the configuration of FIG. 1.

FIG. 4 shows a signaling diagram illustrating an implementation example of the invention according to the configuration of FIG. 2.

### DESCRIPTION OF THE INVENTION

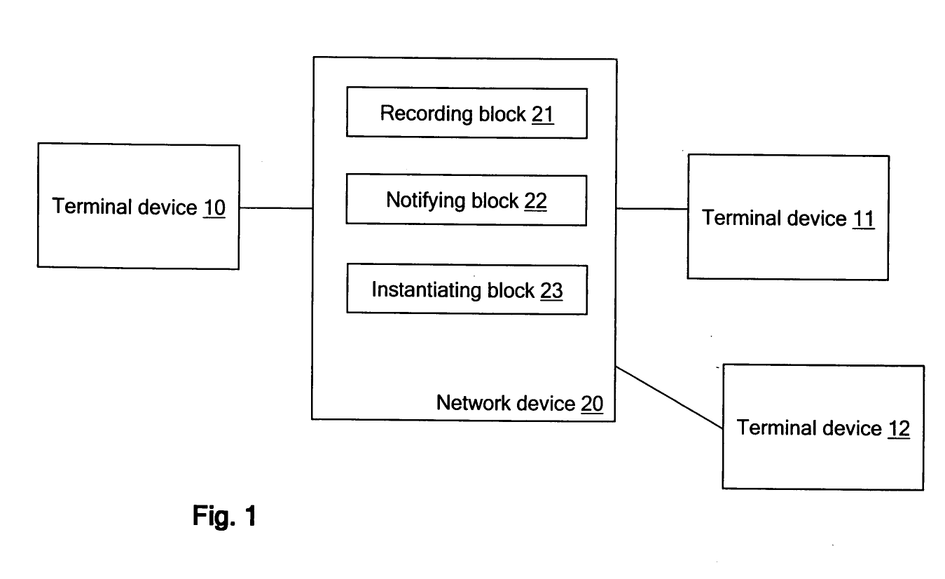

FIG. 1 shows a schematic block diagram illustrating a network device 20 and terminal devices 10, 11, 12 according to an embodiment of the invention.

The network device 20 such as an IM (Instant Messaging) server, chat server or the like in a packet switched communication network such as an IP multimedia network (e.g. an IP Multimedia Subsystem (IMS)) controls a session among at least two users, e.g. among at least two of terminal devices 10, 11, 12 shown in FIG. 1. The network device 20 comprises a recording block 21 for recording contents associated with the session in accordance with a recording request (e.g. commands such as record, stop, pause, etc.) for recording the contents, and a notifying block 22 for notifying information on a status of recording by the recording block 21.

The network device 20 may further comprise an instantiating block 23 for instantiating a record event package for each recording session, wherein the notifying block 22 notifies information on the status of recording associated with the recording session. The recording block 21 may receive the recording request from one of users, e.g. from one of the terminal devices 10-12 involved in the session, and the notifying block 22 may notify the information on the status of recording upon receiving a subscription request.

The recording request may be issued by a user or terminal device participating the session. Alternatively, there may be a case where the user or terminal device that controls the recording is not a participant of the session, i.e. the recording request can be received from an authorized third party. In addition, not all participants of the session may be authorized to record. Stated differently, there are at least two users in an established session, and there may be a controlling user who sends record commands to the session. Moreover, the subscription request may be issued by a user or terminal device participating the session or by an authorized user or terminal device not participating the session.

In the configuration shown in FIG. 1, SIP may be used between the terminal devices 10-12 and the network device 20 as protocol for the recording request, subscription request and for notifying the information.

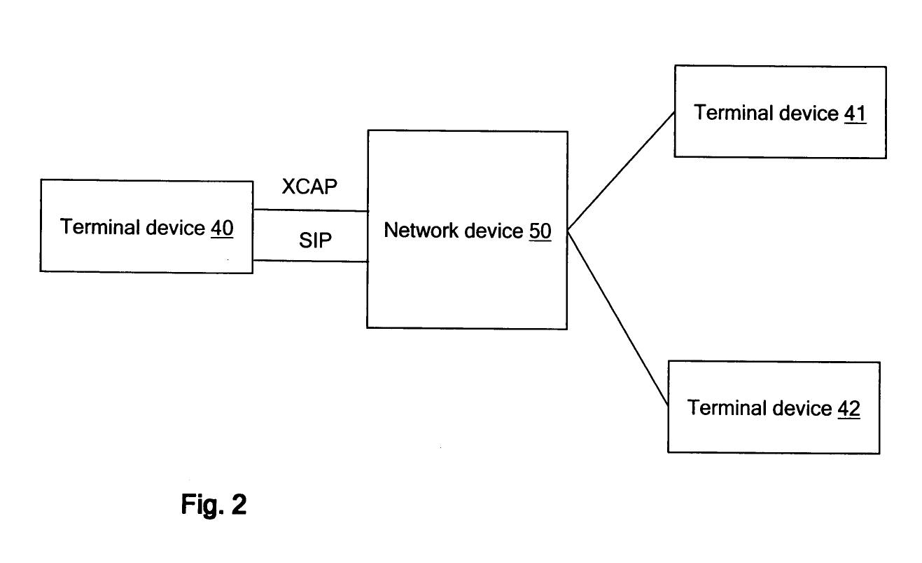

FIG. 2 shows a schematic block diagram illustrating a network device 50 and terminal devices 40-42 according to another embodiment of the invention. This embodiment differs from that shown in FIG. 1 in that an HTTP protocol such as XCAP (Extensible Markup Language (XML) Configuration Access Protocol) is used by e.g. the terminal device 40 to send commands (recording requests), such as record, stop, pause, etc., to the network device 50.

It is to be noted that the network devices and terminal devices shown in FIGS. 1 and 2 may have further functionality for working e.g. as application servers and IMS terminal devices. Here the functions of the network devices and terminal devices relevant for understanding the principles of the invention are described using functional blocks as shown in FIGS. 1 and 2. The arrangement of the functional blocks of the network devices is not to be construed to limit the invention, and the functions of the recording, notifying and generating blocks may be grouped together in one block or further split into sub-blocks.

The terminal devices 10-12 comprise e.g. IMS mobile terminals, typically referred to as User Equipments (UEs). An IMS mobile terminal attaches to a packet network, such as the GPRS (General Packet Radio Services) network, through a radio link. IMS supports also other types of devices and accesses. Personal Digital Assistants and computers are examples of terminal devices that can connect to the IMS. Examples of alternative accesses are WLAN (Wireless Local Area Network) or ADSL (Asymmetric Digital Subscriber Line).

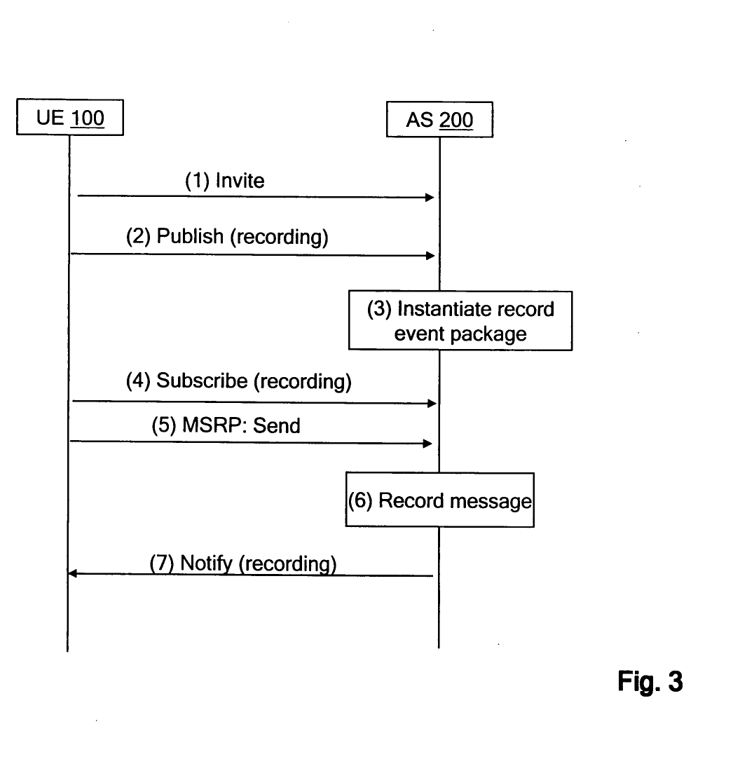

In the following an implementation example of the invention will be described with reference to FIG. 3.

FIG. 3 shows a diagram illustrating signaling between a user equipment (UE) 100 and an application server (AS) 200 according to the configuration of FIG. 1. The terminal devices 10-12 comprise the user equipment 100, and the network device 20 comprises the application server 200.

The idea is to develop a “record” event package in SIP. For this purpose, the functionality is split as described below.

When the UE 100 wants to start or stop recording of a session content, e.g. an IM, in a network through which it communicates, the UE sends a PUBLISH request with an XML content indicating the “user willingness” for the network to record the conversation.

As shown in FIG. 3, in message #1 first of all the UE 100 establishes a new session or joins an existing multi-party session with a SIP INVITE request which traverses allocated P-CSCF (Proxy-CSCF, not shown) and S-CSCF (not shown) which evaluates initial filter criteria and forwards the request to the application server 200 controlling the session. If the new session is created, the session invitation is then forwarded to at least one more User Equipment (not shown), so that the session is established between at least two User Equipments via the application server 200.

Then, in message #2 the UE 100 sends a SIP PUBLISH request towards the AS 200 with an indication of the user's willingness to start the recording of the session content in the network in the format of a publication to the record event package. Such indication can be contained directly in the SIP headers of the PUBLISH request or as part of an enclosing body. Upon receiving the PUBLISH request, the AS 200 creates a new instance of the record event package (procedure #3). Such instance contains the state information of the current recording conditions, including but not limited to: current state (idle, recording, paused), recorded time, size, pointer for retrieval, and any other relevant information. The AS 200 may first check if a user associated with the SIP PUBLISH request has activated or subscribed to a recording service (to be described below), and if so, check if the user has storage space left in the server. Also other policy checks may be performed by the AS 200.

A SIP event package is an additional specification which defines a set of state information to be reported by a notifier (i.e. the AS 200) to a subscriber (i.e. the UE 100) and to be published by a publisher (i.e. the UE 100).

Event packages also define further syntax and semantics based on the framework defined by RFC 3265 required to convey such state information. The key part of this invention is the development of a SIP event package (per RFC 3265) that provides the means to publish record requests from the user, such as record, pause, stop, inform, etc., and means to provide notifications (recording, paused, idle), any potential limit such as size, time, or number of messages, pointer for retrieval, etc.

When the user wants to be informed of the status of the network recording feature, the UE 100 SUBSCRIBEs to the above-mentioned record event package that provides the UE 100 with information on the status of the recording activity. As shown in FIG. 3, in message #4 the UE 100 sends a SUSBCRIBE request towards the AS 200 in which the UE 100 subscribes to the record event package instantiated in procedure #3.

The information on the status of the recording activity is sent in NOTIFY requests (message #7) that contain the status (recording or not), number of stored messages, storage size, any potential limit (size, time, or number of messages), time of start/stop, and any other type of information associated to the instance of the record event package. The application server 200 sends NOTIFY requests including the current status of the record event package to subscribed parties periodically, or whenever there has been a change in the state of the instantiated record event package. Additionally, the application server 200 may have a policy that limits the number of notifications to avoid a high frequency of them. For example, the application server 200 may limit the number of notifications to one every 10 seconds.

As the UE 100 has sent an instant message with the MSRP (Message Session Relay Protocol) SEND request (message #5) which the AS 200 has recorded according to the PUBLISH request (message #2) in a procedure #6, when notifying the number of stored messages in the NOTIFY request (message #7), one stored message is notified to the UE 100.

When the user wants to stop or pause an existing recording, the UE 100 sends a PUBLISH request that contains the stop or pause command according to the syntax of the recording event package. The application server 200 receives the PUBLISH request, acts accordingly, and sends a NOTIFY request to the subscriber UE 100 to inform about the new state, including but not limited to the current status (idle, paused), the total length and size of the current recording, a pointer for retrieval, and all the necessary information.

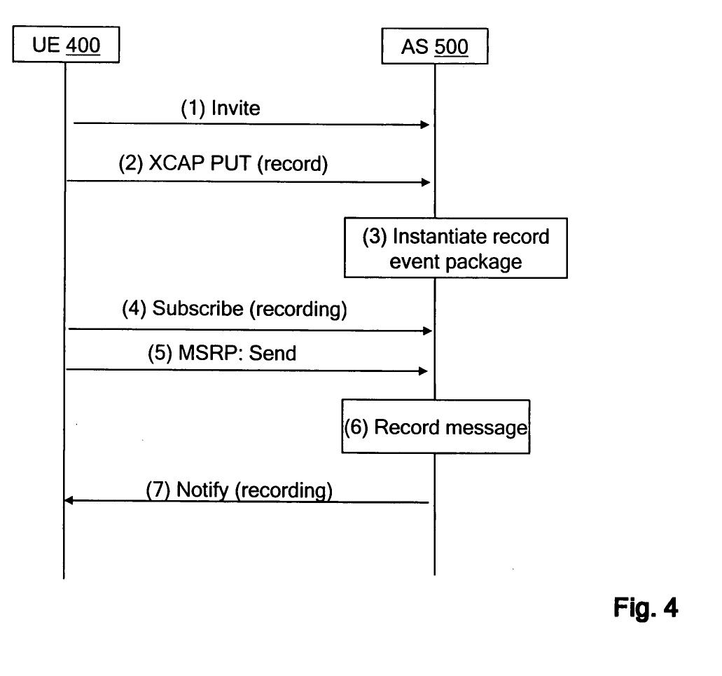

FIG. 4. shows a signalling diagram corresponding to another embodiment describing the mechanism whereby a UE 400 sends commands (e.g., record, pause, stop) to an application server AS 500 implemented with XCAP. The UE 400 uses an XCAP PUT operation to send the commands (record, pause, idle) to the application server 500. As shown in FIG. 4, in message #2 the UE 100 sends an XCAP PUT (record) request towards the AS 200 indicating the user's willingness to start the recording of the session content in the network. Communications and procedures #1 and #3-#7 of FIG. 4 correspond to those described in connection with FIG. 3. It must be noted that the XCAP server can be separated to a standalone server outside the application server 500 (not shown), in which case an interface between the XCAP server and the application server 500 is required.

According to the invention, a server controlling user's participation in a communication session also has a control over recording content of the session based on the instructions received from the user.

It is to be understood that the above description is illustrative of the invention and is not to be construed as limiting the invention. Various modifications and applications may occur to those skilled in the art without departing from the true spirit and scope of the invention as defined by the appended claims. Particularly, the User Equipment device in the description need not necessarily be governed by a human user, but rather the User Equipment may be governed by an automaton. That is the case when, e.g., the User Equipment is the focus of a centralized conference, or when the User Equipment is a service controller.

1. A network device for an IP multimedia network, the network device configured to control a session among at least two users, the network device comprising:
recording means for recording contents associated with the session in accordance with a recording request for recording the contents; and
notifying means for notifying information on a status of recording by the recording means.

2. The network device of claim 1, wherein the notifying means is configured to notify the information in a Session Initiation Protocol (SIP) request.

3. The network device of claim 1, further comprising:
record event package instantiating means for instantiating a record event package for each recording session, wherein the notifying means is configured to notify information on the status of recording associated with said recording session.

4. The network device of claim 1, wherein
the notifying means is configured to notify the information on the status of recording upon receiving a subscription request.

5. A terminal device configured to transmit a recording request for recording, by a network device of an IP multimedia network, which controls a session, contents associated with the session.

6. A terminal device configured to transmit a subscription request for obtaining information on a status of recording, by a network device of an IP multimedia network, contents associated with a session, the network device controlling the session.

7. The terminal device of claim 5, further configured to transmit a subscription request for obtaining information on a status of recording by the network device controlling the session.

8. The terminal device of claim 5, wherein the terminal device participates the session.

9. The terminal device of claim 5, wherein the terminal device is an authorized third party.

10. The terminal device of claim 5, further configured to transmit the recording request in a SIP request.

11. The terminal device of claim 5, further configured to transmit the recording request in a HTTP request.

12. The terminal device of claim 6, further configured to transmit the subscription request in a SIP request.

13. The terminal device of claim 6, further configured to transmit the subscription request relating to a record event package associated with a recording session.

14. A method of controlling a session in an IP multimedia network among at least two users, the method comprising:
recording contents associated with the session in accordance with a recording request for recording the contents; and
notifying information on a status of recording.

15. The method of claim 14, wherein the recording request comprises a Session Initiation Protocol (SIP) request or a Hypertext Transfer Protocol (HTTP) request and wherein the recording request requests at least start or stop of recording.

16. The method of claim 14, wherein the information on the status of recording includes at least one of information on whether contents are being recorded or not, a number of stored contents, a storage size, a storage limit, and a time of start/stop of recording.

17. A method for use in a terminal device, comprising the step of:
transmitting a recording request for recording, by a network device of an IP multimedia network, which controls a session, contents associated with the session.

18. A method for use in a terminal device, comprising the step of:
transmitting a subscription request for obtaining information on a status of recording, by a network device of an IP multimedia network, contents associated with a session, the network device controlling the session.

19. A computer program embodied within a computer readable medium configured to control a session in an IP multimedia network among at least two users, the computer program being configured to perform the steps of:
recording contents associated with the session in accordance with a recording request for recording the contents; and
notifying information on a status of recording.

20. The computer program product according to claim 19, wherein the computer program is directly loadable into an internal memory of the processing device.
